(19) United States
(12) Patent Application Publication
(10) Pub. No.: US 2019/0049018 A1
(43) Pub. Date: Feb. 14, 2019

(54) SEAL RING

(71) Applicant: KABUSHIKI KAISHA RIKEN, Tokyo (JP)

(72) Inventor: TAKUYA OKAMOTO, Kashiwazaki-shi, Niigata (JP)

(21) Appl. No.: 16/077,647

(22) PCT Filed: Feb. 21, 2017
(86) PCT No.: PCT/JP2017/006337

§ 371 Date: Aug. 13, 2018

(30) Foreign Application Priority Data
Feb. 26, 2016 (JP) 2016-035176

(51) Int. Cl. F16J 15/3284

(52) U.S. Cl. CPC F16J 15/3284

(57) ABSTRACT

OBJECT To provide a seal ring capable of reducing friction loss without deteriorating a sealing property.

SOLVING MEANS A seal ring is made of an elastic resin material or an elastic rubber material and includes a pair of side surfaces, a pair of inclined surfaces, and a sliding surface. The pair of side surfaces extend in a radial direction and are parallel to each other. The pair of inclined surfaces extend from end portions of the pair of side surfaces in the radial direction and become closer to each other in a direction away from the pair of side surfaces. The sliding surface connect end portions of the pair of inclined surfaces and project in the radial direction. Due to the provision of the inclined surfaces, the seal ring becomes thinner toward the sliding surface. Thus, the seal ring is easily compressively deformed in the radial direction. Therefore, even if the seal ring is sufficiently compressively deformed in the radial direction to ensure the sealing property, it is possible to reduce pressing force applied on a surface on which the seal ring slides. Thus, the friction between the seal ring and the surface on which the seal ring slides is reduced.

### TECHNICAL FIELD

The present invention relates to a seal ring that can be used for a hydraulic machine.

### BACKGROUND ART

There are known automobiles equipped with various hydraulic machines such as hydraulic-type continuously variable transmissions. In those hydraulic machines, a seal ring for sealing oil is used. The seal ring is fitted to a shaft to be inserted into a housing and seals the space between the shaft and the housing, for example.

In order to achieve an excellent sealing property between the shaft and the housing, the seal ring can be favorably held in close contact with the shaft and the housing without gaps. Therefore, the seal ring is made of an elastic material such as resin, for example. Patent Literatures 1 and 2 have disclosed a seal ring made of resin.

When the hydraulic machine is driven, the seal ring reciprocatingly slides on an inner circumferential surface of the housing. Thus, friction loss that is driving loss due to the friction between the seal ring and the housing is caused in the hydraulic machine. Therefore, it is desirable to reduce the friction loss caused between the seal ring and the housing for reducing the driving loss of the hydraulic machine.

In this regard, there is known a D-ring whose outer circumferential surface is formed in a convex shape and which has a D-shaped cross-section. In the D-ring, the convex-shaped, outer circumferential surface is, at a smaller area, held in contact with the inner circumferential surface of the housing. Therefore, the friction between the D-ring and the housing is reduced, and thus the friction loss caused between the D-ring and the housing is reduced.

### CITATION LIST

### Patent Literature

Patent Literature 1: Japanese Patent Application Laid-open No. 2012-255495
Patent Literature 2: Japanese Patent Application Laid-open No. 2013-194884

### DISCLOSURE OF INVENTION

### Technical Problem

However, since there is growing concern about the environment in recent years, for example, it is desirable to further improve the fuel efficiency of automobiles. Thus, it is desirable to provide a seal ring capable of reducing the friction loss in comparison with the D-ring. On the other hand, in a generally-used seal ring, the friction loss and oil leakage are often in a trade-off relationship. In other words, the reduction of the friction loss often leads to deterioration of the sealing property.

In view of the above-mentioned circumstances, it is an object of the present invention to provide a seal ring capable of reducing the friction loss without deteriorating the sealing property.

### Solution to Problem

In order to accomplish the above-mentioned object, a seal ring according to an embodiment of the present invention is made of an elastic resin material or an elastic rubber material and includes a pair of side surfaces, a pair of inclined surfaces, and a sliding surface.

The pair of side surfaces extend in a radial direction and are parallel to each other.

The pair of inclined surfaces extend from end portions of the pair of side surfaces in the radial direction and become closer to each other in a direction away from the pair of side surfaces.

The sliding surface connect end portions of the pair of inclined surfaces and project in the radial direction.

The sliding surface may be an outer circumferential surface.

The sliding surface may be an inner circumferential surface.

In this seal ring, the outer circumferential surface or the inner circumferential surface is configured as the sliding surface. Due to the provision of the inclined surfaces, the seal ring becomes thinner toward the sliding surface. Thus, the seal ring is easily compressively deformed in the radial direction. Therefore, even if the seal ring is sufficiently compressively deformed in the radial direction to ensure the sealing property, it is possible to reduce pressing force applied on a surface on which the seal ring slides. Thus, the friction between the seal ring and the surface on which the seal ring slides is reduced.

The seal ring may have a symmetrical shape with respect to a plane orthogonal to a center axis.

With this seal ring, an excellent sealing property and low friction loss can be provided irrespective of an attachment direction. Accordingly, the workability in attaching the seal ring is improved.

The pair of inclined surfaces and the pair of side surfaces may form an angle θ smaller than 65°. Further, the angle θ is favorably 10° to 50° and is more favorably 20° to 40°. With this seal ring, a sufficient space can be ensured for the radial compressive deformation, and thus a more stable sealing property can be provided.

The sliding surface may have a circular-arc shape.

The circular-arc shape of the sliding surface may be defined by a circle held in contact with the pair of inclined surfaces.

With these configurations, it becomes possible to easily achieve a design for reducing the friction loss without deteriorating the sealing property in the seal ring.

### Advantageous Effects of Invention

It is possible to provide the seal ring capable of reducing the friction loss without deteriorating the sealing property.

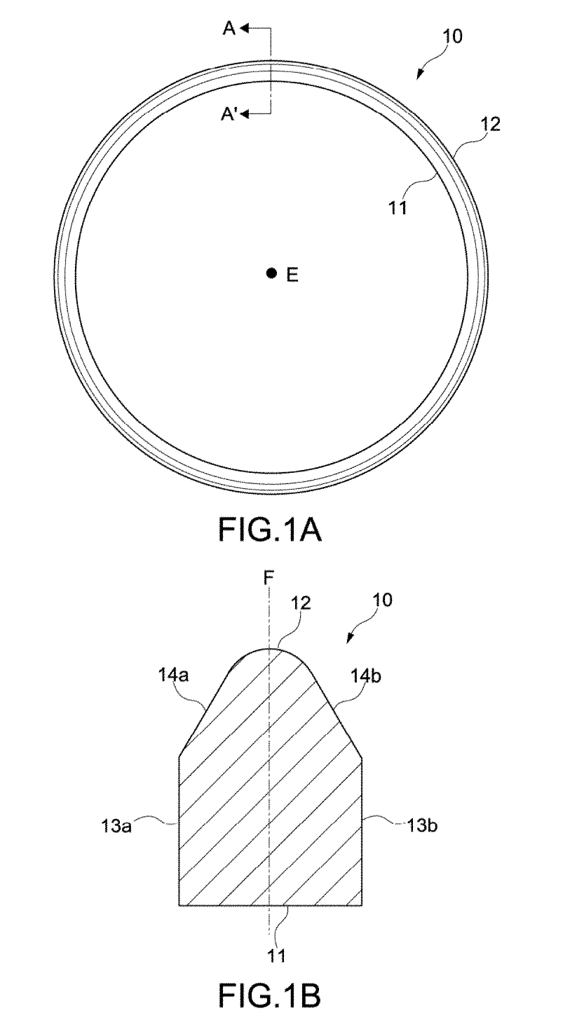

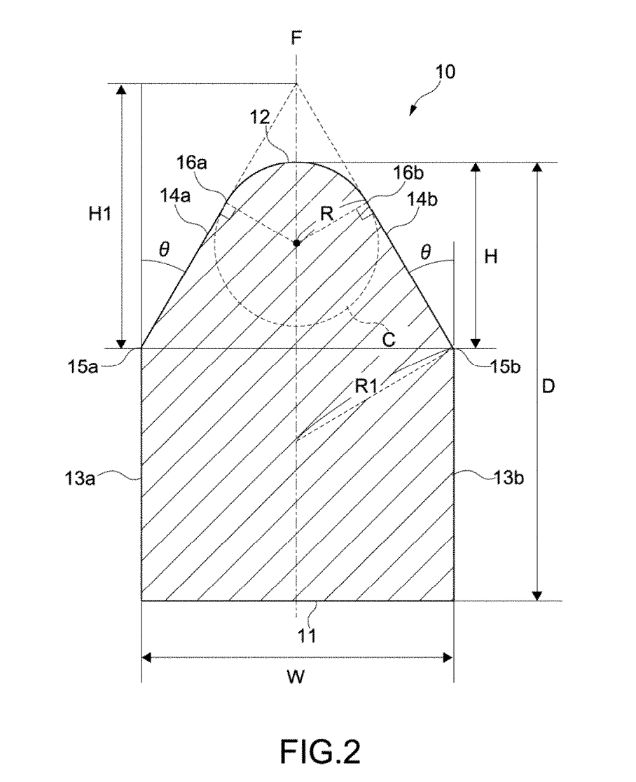

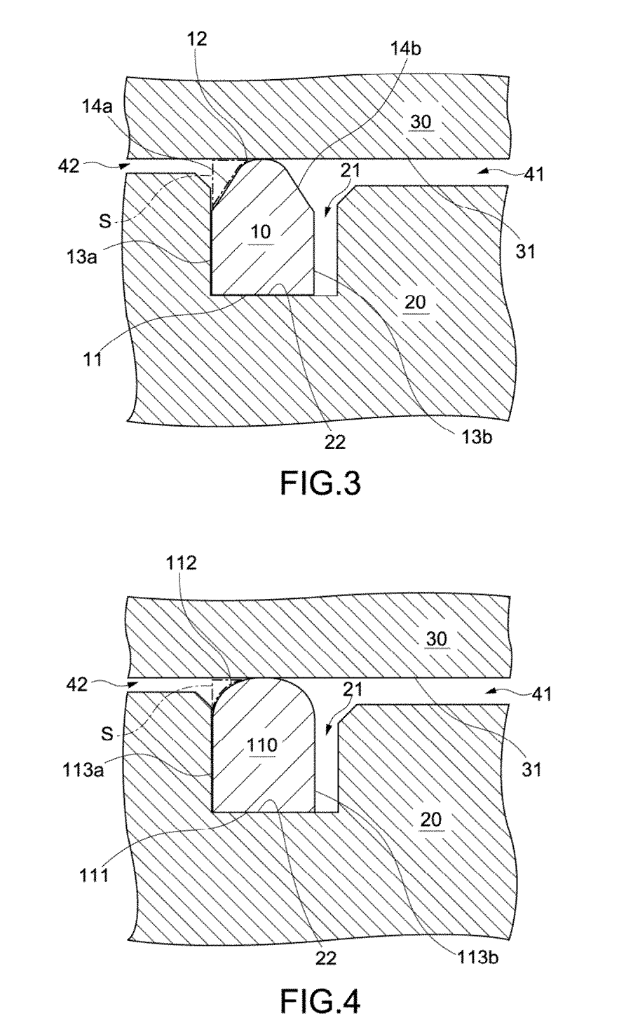

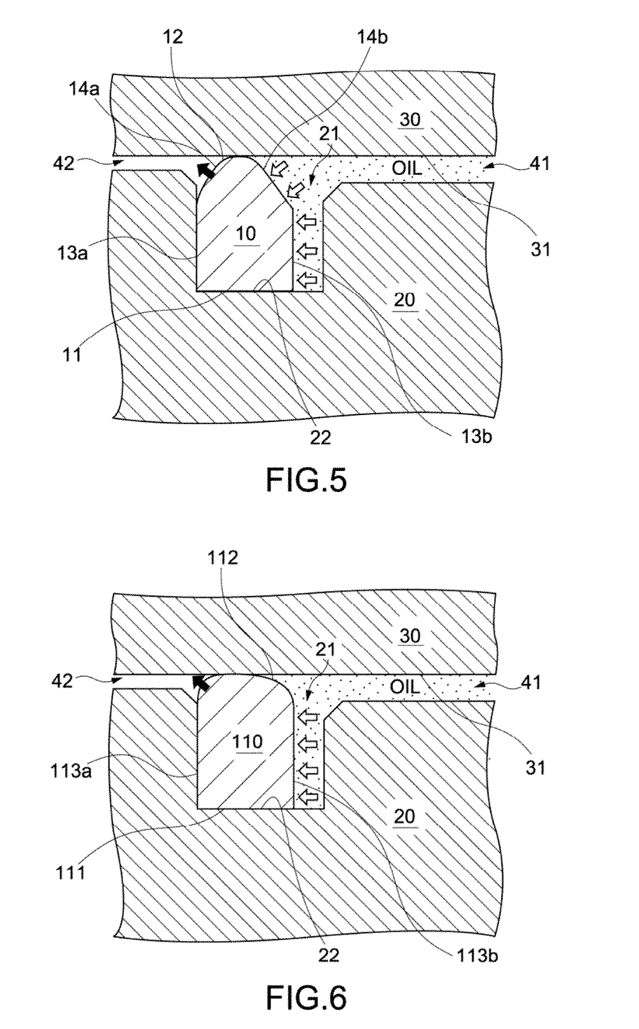

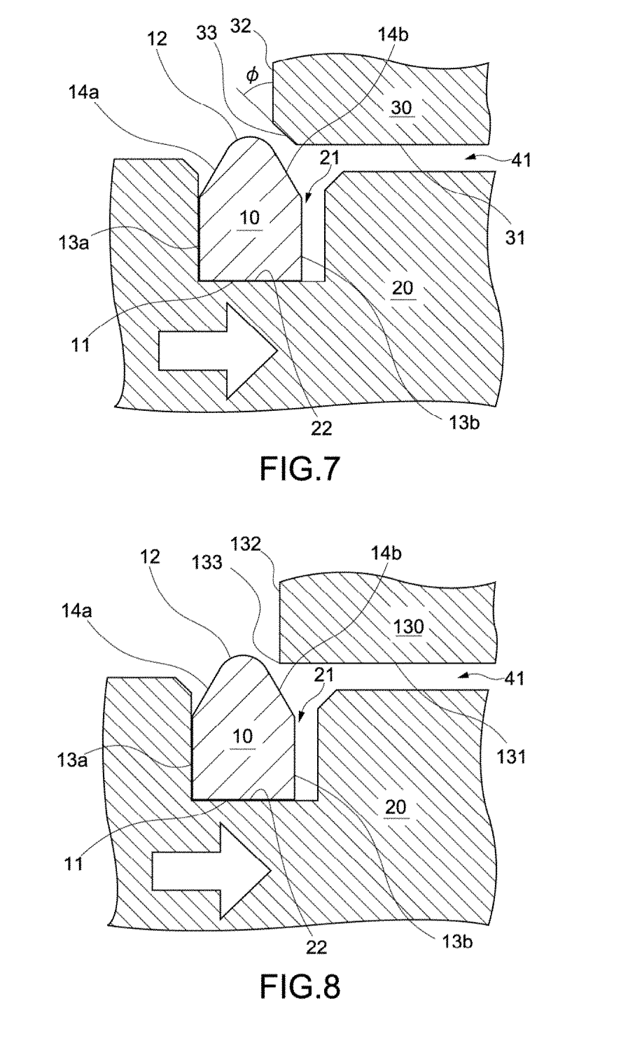

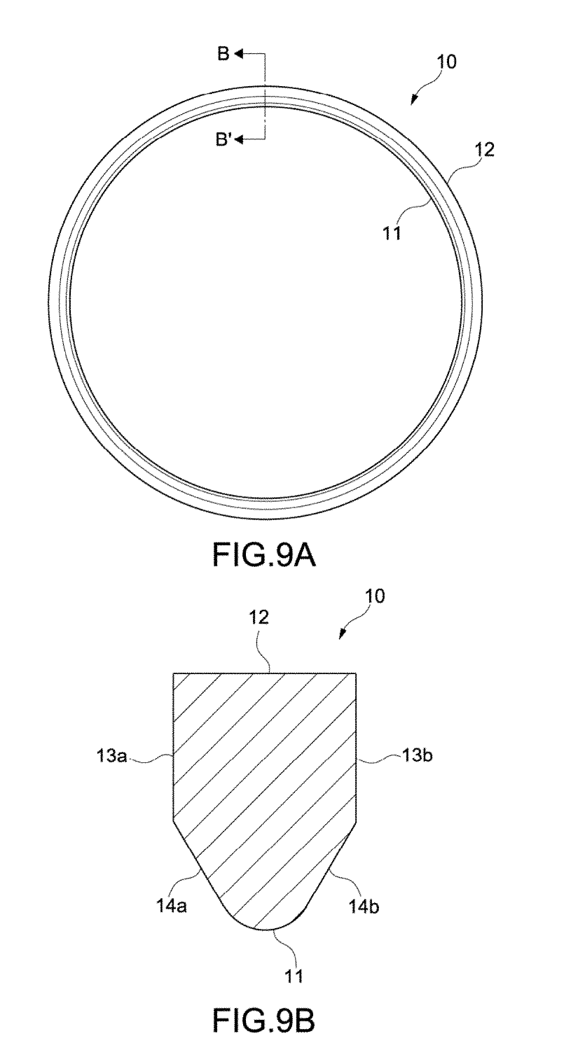

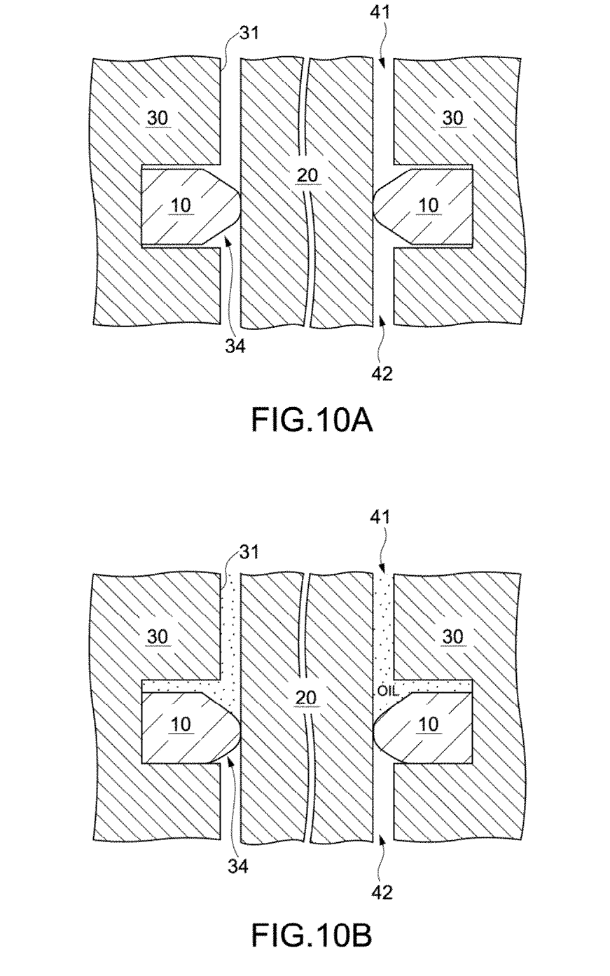

### BRIEF DESCRIPTION OF DRAWINGS

[FIG. 1A] A plan view of a seal ring according to a first embodiment of the present invention.

[FIG. 1B] A cross-sectional view of the seal ring according to the first embodiment, which is taken along the A-A′ line of FIG. 1A.

[FIG. 2] An enlarged cross-sectional view of the seal ring according to the first embodiment.

[FIG. 3] A cross-sectional view showing a use state of the seal ring according to the first embodiment.

[FIG. 4] A cross-sectional view showing a use state of a seal ring associated with the present invention.

[FIG. 5] A cross-sectional view showing a use state of the seal ring according to the first embodiment.

[FIG. 6] A cross-sectional view showing a use state of the seal ring associated with the present invention.

[FIG. 7] A cross-sectional view of a housing according to the first embodiment.

[FIG. 8] A cross-sectional view a housing associated with the present invention.

[FIG. 9A] A plan view of a seal ring according to a second embodiment of the present invention.

[FIG. 9B] A cross-sectional view of the seal ring according to the second embodiment, which is taken along the B-B′ line of FIG. 9A.

[FIG. 10A] A cross-sectional view showing a use state of the seal ring according to the second embodiment.

[FIG. 10B] A cross-sectional view showing a use state of the seal ring according to the second embodiment.

### MODE(S) FOR CARRYING OUT THE INVENTION

Hereinafter, embodiments of the present invention will be described with reference to the drawings.

### 1. First Embodiment

1.1 Configuration of Seal Ring 10

FIGS. 1A and 1B are diagrams each showing a seal ring 10 according to a first embodiment of the present invention. FIG. 1A is a plan view of the seal ring 10. FIG. 1B is a cross-sectional view of the seal ring 10, which is taken along the A-A′ line of FIG. 1A.

As shown in FIG. 1A, the seal ring 10 is formed in a ring shape about a center axis E. FIG. 1B shows a plane F which is orthogonal to the center axis E and extends in a radial direction of the seal ring 10. The plane F extends through the center of the seal ring 10 and the seal ring 10 has a symmetrical shape with respect to the plane F.

The seal ring 10 is made of an elastic material. The elastic material of the seal ring 10 needs to have a physical property that enables the seal ring 10 to be constantly held in close contact with the shaft and the housing without gaps and seal the space between the shaft and the housing.

Specifically, the elastic material of the seal ring 10 needs to have an excellent pressure-resistant property. In general, an elastic material having high hardness and high tensile strength can provide the excellent pressure-resistant property. In view of this, the elastic material of the seal ring 10 favorably has shore A hardness of 70 or more and tensile strength of 8 MPa or more. The shore A hardness of the elastic material can be measured by a type A durometer on the basis of JIS K7215, for example. A measurement sample obtained by cutting the elastic material in an appropriate shape can be used therefor.

The tensile strength of the elastic material can be provided as maximum stress in a tensile test based on JIS K6251, for example. In the tensile test, the elastic material can be machined into a dumbbell specimen (JIS No. 3). Further, the tensile speed in the tensile test can be set to 500 mm/min.

Further, in order to keep the close contact with the shaft and the housing for a long period, the elastic material of the seal ring 10 needs to have a low compression set. In view of this, the elastic material of the seal ring 10 favorably has a compression set of 90% or less after it is retained at 150° C. for 100 hours.

The compression set of the elastic material can be measured on the basis of JIS K6262, for example. A measurement sample obtained by cutting the elastic material to have a length of 15 mm, a width of 5 mm, and a thickness of 2 mm can be used therefor.

In this measurement, the measurement sample sandwiched by spacers is first compressed by 25% by applying pressurizing force between the spacers and is retained at 150° C. for 100 hours. After that, the pressurizing force between the spacers is cancelled and the measurement sample is left to stand for 30 minutes at room temperature. The compression set at 150° C. can be calculated in accordance with the following expression.

(Compression set at 150° C.)=[(t0−t2)/t0−t1]×100[%]

(Where t0: thickness (mm) of the measurement sample before the test, t1: thickness (mm) of the spacer, t2: thickness (mm) of the measurement sample after the test (after it is left to stand for 30 minutes at the room temperature))

The elastic material of the seal ring 10 can be selected from various resin materials and various rubber materials on the basis of the shore A hardness, the tensile strength, the compression set, and the like as described above. In addition, the elastic material of the seal ring 10 may be configured as a composite material obtained by adding various fillers to a resin material or a rubber material.

The seal ring 10 includes an inner circumferential surface 11 and an outer circumferential surface 12 which are opposed to each other in the radial direction. The inner circumferential surface 11 is configured as a cylindrical surface facing inward in the radial direction and being parallel to the center axis E. The outer circumferential surface 12 is configured as a cask-like curve surface facing outward in the radial direction and projecting outward in the radial direction. The outer circumferential surface 12 has a smaller width in a direction of the center axis E than the inner circumferential surface 11. In the seal ring 10, the outer circumferential surface 12 is configured as a sliding surface that slides on the housing.

Further, the seal ring 10 includes side surfaces 13a, 13b opposed to each other in the direction of the center axis E and parallel to the plane F. The side surfaces 13a, 13b each extend outward in the radial direction from the both sides of the inner circumferential surface 11 in the direction of the center axis E.

For incorporating the seal ring 10 in the shaft and the housing, the seal ring 10 is first attached to a groove portion of the shaft. The seal ring 10 has a symmetrical shape in the direction of the center axis E, and thus it is unnecessary to consider the direction of the seal ring 10 when attaching the seal ring 10 to the groove portion of the shaft. Accordingly, the workability in attaching the seal ring 10 to the groove portion of the shaft is improved.

Further, an inside diameter of the seal ring 10 (diameter of the inner circumferential surface 11) is slightly smaller than a diameter of a bottom of the groove portion of the shaft. Thus, the seal ring 10 is fitted into the groove portion of the shaft by slightly expanding the seal ring 10 in the radial direction. Accordingly, the inner circumferential surface 11 of the seal ring 10 is held in close contact with the bottom of the groove portion of the shaft.

Next, the shaft with the seal ring 10 attached to the groove portion is inserted into the housing. An outside diameter of the seal ring 10 attached to the groove portion of the shaft (diameter of the outer circumferential surface 12) is slightly larger than an inside diameter of the housing. Thus, the seal ring 10 is inserted into the housing together with the shaft by the seal ring 10 being slightly compressively deformed in the radial direction. Accordingly, the outer circumferential surface 12 of the seal ring 10 is held in close contact with the inner circumferential surface of the housing.

That is, the seal ring 10 incorporated in the shaft and the housing is compressively deformed in the radial direction while the seal ring 10 is sandwiched between the shaft and the housing. Thus, due to elastic force to expand in the radial direction, the seal ring 10 presses the inner circumferential surface 11 against the bottom of the groove portion of the shaft and presses the outer circumferential surface 12 against the inner circumferential surface of the housing. Accordingly, the seal ring 10 can seal the space between the shaft and the housing.

When the shaft reciprocatingly slides on the housing, it slides while the outer circumferential surface 12 of the seal ring 10 is held in contact with the inner circumferential surface of the housing, and thus the sealing property between the shaft and the housing is maintained. The seal ring 10 includes inclined surfaces 14a, 14b in order to reduce the friction between the outer circumferential surface 12 and the inner circumferential surface of the housing.

The inclined surfaces 14a, 14b connect the side surfaces 13a, 13b to the outer circumferential surface 12, respectively. The inclined surfaces 14a, 14b are each configured as a flat surface inclined with respect to the plane F, and are closer to each other from the side surfaces 13a, 13b to the outer circumferential surface 12. Therefore, the seal ring 10 is gradually thinner from the side surfaces 13a, 13b to the outer circumferential surface 12 along the inclined surfaces 14a, 14b. The seal ring 10 has a shape projecting outward in the radial direction.

As the seal ring 10 becomes thinner along the inclined surfaces 14a, 14b, it is more easily compressively deformed in the radial direction. That is, the seal ring 10 is easily compressively deformed in the radial direction on the side of the outer circumferential surface 12, and thus the seal ring 10 is compressively deformed in the radial direction with smaller force. Therefore, also in a state in which the seal ring 10 is sufficiently compressively deformed in the radial direction, the elastic force can be reduced.

Accordingly, pressing force applied from the outer circumferential surface 12 to the inner circumferential surface of the housing is reduced, and thus the friction when the outer circumferential surface 12 slides on the inner circumferential surface of the housing is reduced. That is, with the seal ring 10, it is possible to reduce the friction loss against the housing while providing a sufficient close contact property of the outer circumferential surface 12 with the inner circumferential surface of the housing.

FIG. 2 is an enlarged cross-sectional view of the seal ring 10, which shows FIG. 1B in an enlarged view. Hereinafter, details of the seal ring 10 will be described with reference to FIG. 2.

FIG. 2 shows a thickness W of the seal ring 10 in the direction of the center axis E and a height D of the seal ring 10 in the radial direction. The thickness W and the height D of the seal ring 10 are determined in a manner that depends on the configurations of the shaft and the housing such that it can suitably seal the space between the shaft and the housing.

Specifically, the thickness W of the seal ring 10 is set to be slightly smaller than the groove width of the groove portion of the shaft. Accordingly, a suitable distance is provided between the seal ring 10 and a wall surface of the groove portion of the shaft, and the seal ring 10 is suitably received in the groove portion of the shaft.

Further, the height D of the seal ring 10 is defined by a difference between the inside diameter and the outside diameter of the seal ring 10, and the height D of the seal ring 10 is set to be slightly larger than a distance between the bottom of the groove portion of the shaft and the inner circumferential surface of the housing. Accordingly, the seal ring 10 can be compressively deformed between the bottom of the groove portion of the shaft and the inner circumferential surface of the housing.

The outer circumferential surface 12 is formed in a circular-arc shape defined by an inscribed circle C shown in FIG. 2. The inscribed circle C is tangent to in contact with the inclined surfaces 14a, 14b at connection portions 16a, 16b. That is, a radius R of the inscribed circle C is determined such that the inscribed circle C is tangent to the inclined surfaces 14a, 14b. Accordingly, the outer circumferential surface 12 is smoothly connected to the inclined surfaces 14a, 14b at the connection portions 16a, 16b with no steps and no irregularities.

The inclined surfaces 14a, 14b are connected to the side surfaces 13a, 13b at ridge portions 15a, 15b and form an angle θ with a plane including the side surfaces 13a, 13b, respectively. The ridge portions 15a, 15b may be chamfered or may be R-surfaces or C-surfaces.

The angle θ of the inclined surfaces 14a, 14b can be determined as appropriate.

For example, in the seal ring 10, a part of the height D, which is occupied by the inclined surfaces 14a, 14b and the outer circumferential surface 12, can be changed by using the angle θ of the inclined surfaces 14a, 14b. That is, an amount of projection H of the seal ring 10 outward in the radial direction can be adjusted by using the angle θ of the inclined surfaces 14a, 14b.

More specifically, when the inclination of the inclined surfaces 14a, 14b with respect to the side surfaces 13a, 13b is made gentle by decreasing the angle θ, the amount of projection H of the seal ring 10 increases. Accordingly, a space for the radial compressive deformation of the seal ring 10 is wider, and thus the seal ring 10 is gradually compressively deformed in the radial direction. Thus, with the seal ring 10, more stable elastic force can be provided, and thus the sealing property is improved.

In contrast, when the inclination of the inclined surfaces 14a, 14b with respect to the side surfaces 13a, 13b is made steep by increasing the angle θ, the amount of projection H of the seal ring 10 decreases. Accordingly, the space for the radial compressive deformation of the seal ring 10 is narrower, and thus the seal ring 10 is barely compressively deformed in the radial direction as a whole. Thus, with the seal ring 10, the attitude becomes stable also in a state in which hydraulic pressure is applied.

Thus, it is favorable that the angle θ of the inclined surfaces 14a, 14b is larger than 0° and is smaller than 65°. Further, the angle θ of the inclined surfaces 14a, 14b is favorably 10° to 50° and is more favorably 20° to 40°.

An example of a method of designing the seal ring 10 will be described still with reference to FIG. 2. For designing the seal ring 10, after the thickness W and the height D are determined in a manner that depends on the configurations of the shaft and the housing, the radius R of the inscribed circle C, the angle θ of the inclined surfaces 14a, 14b, and the amount of projection H of the seal ring 10 can be determined.

First of all, a theoretically maximum value of the amount of projection H of the seal ring 10 is considered. Assuming that the amount of projection H is gradually increased, when the amount of projection H becomes H1 shown in FIG. 2, the inclined surfaces 14a, 14b are connected to each other in the plane F and the outer circumferential surface 12 disappears. That is, for making the outer circumferential surface 12 exist, the amount of projection H needs to be smaller than H1.

This condition can be represented by Expression (1) as follows.

H<W/2 tan θ(=H1) (1)

By modifying Expression (1), Expression (2) as follows is obtained.

θ< tan⁻¹(W/2H) (2)

Further, by adding to Expression (2) a condition that the angle θ of the inclined surfaces 14a, 14b is larger than zero, Expression (3) as follows is obtained.

0<θ< tan⁻¹(W/2H) (3)

Therefore, in the seal ring 10 according to this embodiment, after the amount of projection H is determined in advance, the angle θ can be determined so as to satisfy Expression (3).

Next, a theoretically maximum value of the radius R of the inscribed circle C is considered. Assuming that the radius R of the inscribed circle C is gradually increased, when the radius R of the inscribed circle C becomes R1 shown in FIG. 2, the connection portions 16a, 16b overlap the ridge portions 15a, 15b and the inclined surfaces 14a, 14b disappear. That is, for making the inclined surfaces 14a, 14b exist, the radius R of the inscribed circle C needs to be smaller than R1.

This condition can be represented by Expression (4) as follows.

9R<W/2 cos θ(=R1) (4)

By adding to Expression (4) a condition that the radius R of the inscribed circle C is larger than zero, Expression (5) as follows is obtained.

0<R <W/2 cos θ (5)

Therefore, in the seal ring 10 according to this embodiment, after the angle θ is determined in advance, the radius R of the inscribed circle C can be determined so as to satisfy Expression (5).

1.2 Action and Effect of Seal Ring 10

FIG. 3 is a cross-sectional view of the seal ring 10 incorporated in a shaft 20 and a housing 30. The seal ring 10 is fitted into a groove portion 21 of the shaft 20. The seal ring 10 is inserted into the housing 30 together with the shaft 20.

As described above, the seal ring 10 is compressively deformed in the radial direction while it is sandwiched between the bottom 22 of the groove portion 21 of the shaft 20 and an inner circumferential surface 31 of the housing 30. Then, due to the elastic force to expand in the radial direction, the seal ring 10 presses the inner circumferential surface 11 against the bottom 22 of the groove portion 21 of the shaft 20 and presses the outer circumferential surface 12 against the inner circumferential surface 31 of the housing 30.

Accordingly, the seal ring 10 seals the space between the bottom 22 of the groove portion 21 of the shaft 20 and the inner circumferential surface 31 of the housing 30. In this manner, gaps 41, 42 between the shaft 20 and the housing 30 are partitioned off by the seal ring 10, and thus oil cannot move between the gaps 41, 42.

In the seal ring 10, due to the provision of the inclined surfaces 14a, 14b as described above, the radial compressive deformation easily occurs. Therefore, in the seal ring 10, the elastic force is reduced, and the friction when the outer circumferential surface 12 slides on the inner circumferential surface 31 of the housing 30 is reduced.

FIG. 4 shows a state in which a D-ring 110 associated with this embodiment is used instead of the seal ring 10 according to this embodiment. The D-ring 110 has an outer circumferential surface 112 formed in a convex, semi-circular shape and has a D-shaped cross-section. In the D-ring 110, the outer circumferential surface 112 is directly connected to side surfaces 113a, 113b.

That is, the D-ring 110 does not include configurations corresponding to the inclined surfaces 14a, 14b of the seal ring 10 according to this embodiment.

The D-ring 110 is also compressively deformed in the radial direction as in the seal ring 10 according to this embodiment. Thus, due to the elastic force to expand in the radial direction, the D-ring 110 presses an inner circumferential surface 111 against the bottom 22 of the groove portion 21 of the shaft 20 and presses the outer circumferential surface 112 against the inner circumferential surface 31 of the housing 30.

Accordingly, the D-ring 110 seals the space between the bottom 22 of the groove portion 21 of the shaft 20 and the inner circumferential surface 31 of the housing 30. In this manner, the gaps 41, 42 between the shaft 20 and the housing 30 are partitioned off by the D-ring 110, and thus oil cannot move between the gaps 41, 42.

However, the D-ring 110 has a large thickness as a whole, and thus the D-ring 110 is barely compressively deformed in the radial direction. That is, the D-ring 110 shown in FIG. 4 receives larger force from the shaft 20 and the housing 30 so as to achieve radial compressive deformation at approximately the same level as that of the seal ring 10 shown in FIG. 3. Therefore, the elastic force of the D-ring 110 shown in FIG. 4 is larger than the elastic force of the seal ring 10 shown in FIG. 3.

Thus, the pressing force applied on the inner circumferential surface 31 of the housing 30 from the outer circumferential surface 112 of the D-ring 110 shown in FIG. 4 is larger than the pressing force applied on the inner circumferential surface 31 of the housing 30 from the outer circumferential surface 12 of the seal ring 10 shown in FIG. 3. Therefore, the outer circumferential surface 112 of the D-ring 110 has larger friction with the inner circumferential surface 31 of the housing 30 than the outer circumferential surface 12 of the seal ring 10 according to this embodiment.

In this manner, the friction loss between the seal ring 10 according to this embodiment and the housing 30 is reduced in comparison with the D-ring 110.

FIG. 5 shows a state in which oil flows into the gap 41 between the shaft 20 and the housing 30 and hydraulic pressure is applied on the seal ring 10 after the state shown in FIG. 3.

At this time, in the seal ring 10, hydraulic pressure is applied on the one side surface 13b and the other side surface 13a is pressed against the wall surface of the groove portion 21 of the shaft 20. Accordingly, in the seal ring 10, the side surface 13a is also held in close contact with the groove portion 21 of the shaft 20 in addition to the inner circumferential surface 11, and thus the sealing property with the shaft 20 is further improved.

Further, the seal ring 10 is deformed due to creeping and the like with hydraulic pressure. More specifically, in the seal ring 10, when hydraulic pressure is exerted on the side surface 13b and the inclined surface 14b, the portion compressed between the side surfaces 13a, 13b is pushed out toward the inclined surface 14a on which hydraulic pressure is not exerted. Accordingly, the seal ring 10 undergoes creep deformation as shown in FIG. 5. That is, the outer circumferential surface 12 is pulled toward the side surface 13a and the inclined surface 14a bulges.

The seal ring 10 becomes thinner along the inclined surfaces 14a, 14b, and thus a wedge-shaped space S (see FIG. 3) formed at a position adjacent to the inclined surface 14a is relatively large. Therefore, even if the seal ring 10 is deformed in such a manner, the seal ring 10 remains within the wedge-shaped space S. Thus, it is possible to prevent the deformed seal ring 10 from departing from the wedge-shaped space S and entering the gaps 41, 42 between the shaft 20 and the housing 30.

On the other hand, FIG. 6 shows a state in which oil flows into the gap 41 between the shaft 20 and the housing 30 and hydraulic pressure is applied on the D-ring 110 after the state shown in FIG. 4.

In the D-ring 110, when hydraulic pressure is exerted on the side surface 113b, the portion compressed between the side surfaces 113a, 113b is pushed out toward the outer circumferential surface 112. Accordingly, the D-ring 110 undergoes creep deformation as shown in FIG. 6. That is, the top of the outer circumferential surface 112 is pulled toward the side surface 113a and a portion of the outer circumferential surface 112, which is on the side of the side surface 113a on which hydraulic pressure is not exerted, bulges.

The D-ring 110 does not include the configurations corresponding to the inclined surfaces 14a, 14b of the seal ring 10 according to this embodiment, and the wedge-shaped space S (see FIG. 4) adjacent to the outer circumferential surface 112 is small. Therefore, when the D-ring 110 is deformed in such a manner, the D-ring 110 cannot remain within the wedge-shaped space S and enters the gaps 41, 42 between the shaft 20 and the housing 30 in some cases.

In those cases, if the deformed D-ring 110 is sandwiched between the shaft 20 and the housing 30 in the gaps 41, 42, there is a possibility that reciprocating sliding of the shaft 20 against the housing 30 may have a problem. In addition, if the bulge generated in the D-ring 110 is broken, there is a possibility that broken pieces may be mixed into the hydraulic machine.

1.3 Modified Example of Seal Ring 10

The configuration of the seal ring 10 can be changed as appropriate within a range in which the above-mentioned action and effect can be provided.

Specifically, the outer circumferential surface 12 is not limited to the circular-arc shape and only needs to project outward in the radial direction. For example, the curvature of the outer circumferential surface 12 does not need to be constant and may be varied continuously.

Further, the inclined surfaces 14a, 14b do not need to be precisely flat and may be bent in a convex shape or a recess shape, for example.

In addition, the shape of the inner circumferential surface 11 is not limited to the cylindrical shape and may be bent in a convex shape or a recess shape, for example.

In addition, the shape of the seal ring 10 does not need to be precisely symmetric with respect to the plane F. For example, the outer circumferential surface 12 may be deviated to one of the side surfaces 13a, 13b.

1.4 Housing 30

FIG. 7 is a diagram for describing an operation of inserting the shaft 20 with the seal ring 10 according to this embodiment inserted therein into the housing 30. The housing 30 is configured such that the shaft 20 with the seal ring 10 according to this embodiment inserted therein can be smoothly inserted therein through an insertion port formed in an end surface 32.

In the seal ring 10 attached to the shaft 20 before it is inserted into the housing 30, the outer circumferential surface 12 projects beyond the inner circumferential surface 31 of the housing 30. Therefore, for inserting the shaft 20 into the housing 30 together with the seal ring 10, it is necessary to compressively deform the seal ring 10 in the radial direction.

In this point, the housing 30 includes a chamfered portion 33 that connects the end surface 32 to the inner circumferential surface 31. The chamfered portion 33 is typically formed by chamfering an edge portion at which the end surface 32 and the inner circumferential surface 31 are to be orthogonal to each other. An angle ϕ of the chamfered portion 33 of the housing 30 with respect to the end surface 32 is larger than the angle θ of the inclined surfaces 14a, 14b of the seal ring 10.

By inserting the shaft 20 from the end surface 32 of the housing 30, the seal ring 10 finally reaches the end surface 32 of the housing 30 and the outer circumferential surface 12 of the seal ring 10 is brought into contact with the chamfered portion 33 of the housing 30. Then, by pushing the shaft 20 into the housing 30, the outer circumferential surface 12 moves toward the inner circumferential surface 31 along the chamfered portion 33. Correspondingly, the seal ring 10 is pressed by the chamfered portion 33 and is gradually compressively deformed in the radial direction.

Then, the outer circumferential surface 12 of the seal ring 10 reaches the inner circumferential surface 31 of the housing 30 and the state shown in FIG. 3 is obtained. In this manner, only by the operation of pushing the shaft 20 into the housing 30, the shaft 20 can be smoothly inserted into the housing 30 while compressively deforming the seal ring 10 in the radial direction.

FIG. 8 shows a state in which a housing 130 associated with this embodiment is used instead of the housing 30 according to this embodiment. In the housing 130, an edge portion 133 at which the end surface 32 and the inner circumferential surface 31 are to be orthogonal to each other is not chamfered.

By inserting the shaft 20 through an end surface 132 of the housing 130, the seal ring 10 finally reaches the end surface 132 of the housing 130 and the outer circumferential surface 12 of the seal ring 10 or the inclined surface 14a is brought into contact with the edge portion 133 of the housing 30. The edge portion 133 of the housing 30 applies, on the seal ring 10, reaction force in a direction opposite to the pushing direction of the shaft 20.

Thus, it is difficult to insert the shaft 20 into the housing 130. Further, when the shaft 20 is pushed into the housing 130 with strong force to make the seal ring 10 reach an inner circumferential surface 131 of the housing 130, excessive force easily acts on the seal ring 10. Accordingly, there is a possibility that the seal ring 10 may be damaged.

### 2. Second Embodiment

A seal ring 10 according to the second embodiment of the present invention is different from the first embodiment in that the sliding surface is the inner circumferential surface 11, not the outer circumferential surface 12. In the second embodiment, configurations corresponding to those of the first embodiment will be denoted by the same reference signs as those of the first embodiment and the configurations common to those of the first embodiment will be omitted as appropriate.

FIGS. 9A and 9B are diagrams showing the seal ring 10 according to the second embodiment. FIG. 9A is a plan view of the seal ring 10 and FIG. 9B is a cross-sectional view of the seal ring 10, which is taken along the B-B′ line of FIG. 9A. The seal ring 10 according to this embodiment has a configuration in which the inside and outside in the radial direction are inverted in comparison with the configuration of the first embodiment shown in FIGS. 1A and 1B.

That is, the inner circumferential surface 11 is configured as a cask-like curve surface facing inward in the radial direction and projecting inward in the radial direction. The outer circumferential surface 12 is configured as a cylindrical surface facing outward in the radial direction. The inclined surfaces 14a, 14b are provided to the side surfaces 13a, 13b on the side of the inner circumferential surface 11. The inclined surfaces 14a, 14b connect the side surfaces 13a, 13b to the inner circumferential surface 11, respectively.

FIG. 10A is a cross-sectional view of the seal ring 10 incorporated in the shaft 20 and the housing 30. A groove portion 34 in which the seal ring 10 is fitted is formed in the inner circumferential surface 31 of the housing 30. In the state shown in FIG. 10A, the shaft 20 is inserted in the housing 30 with the seal ring 10 fitted therein.

The seal ring 10 is compressively deformed in the radial direction and seals the space between the bottom of the groove portion 34 of the housing 30 and the outer circumferential surface of the shaft 20. In this manner, the gaps 41, 42 between the shaft 20 and the housing 30 are partitioned off by the seal ring 10, and thus oil cannot move between the gaps 41, 42.

FIG. 10B shows in a state in which oil flows into the gap 41 between the shaft 20 and the housing 30 and hydraulic pressure is applied on the seal ring 10 after the state shown in FIG. 10A. As shown in FIG. 10B, in the seal ring 10, even if the inclined surfaces 14a, 14b are deformed due to hydraulic pressure, it is possible to prevent the inclined surfaces 14a, 14b from entering the gaps 41, 42.

### 3. Other Embodiments

Hereinabove, the embodiments of the present invention have been described, though the present invention is not limited to the above embodiments. Various modifications can be made without departing from the gist of the present invention as a matter of course.

For example, the configuration of the seal ring 10 of the present invention is useful not only to a seal for oil but also to seals for liquid and gas other than oil.

### REFERENCE SIGNS LIST

10 seal ring
11 inner circumferential surface
12 outer circumferential surface
13a, 13b side surface
14a, 14b inclined surface
15a, 15b ridge portion
16a, 16b connection portion
θ angle of inclined surface
C inscribed circle
R radius of inscribed circle

1. A seal ring made of an elastic resin material or an elastic rubber material, comprising:
a pair of side surfaces extending in a radial direction and parallel to each other;
a pair of inclined surfaces extending from end portions of the pair of side surfaces in the radial direction, becoming closer to each other in a direction away from the pair of side surfaces, and forming an angle θ smaller than 65° with the pair of side surfaces; and
a sliding surface connecting end portions of the pair of inclined surfaces and projecting in the radial direction.

2. The seal ring according to claim 1, wherein
the sliding surface is an outer circumferential surface.

3. The seal ring according to claim 1, wherein
the sliding surface is an inner circumferential surface.

4. The seal ring according to claim 1, having a symmetrical shape with respect to a plane orthogonal to a center axis.

5. (canceled)

6. The seal ring according to claim 1, wherein
the sliding surface has a circular-arc shape.

7. The seal ring according to claim 6, wherein
the circular-arc shape of the sliding surface is defined by a circle held in contact with the pair of inclined surfaces.
